(19) United States
(12) Patent Application Publication
(10) Pub. No.: US 2004/0044109 A1
(43) Pub. Date: Mar. 4, 2004

(54) Dust-free stabilizer compositions for plastic materials and method for the production thereof

(76) Inventor: Bernhard Bartnick, Monheim (DE)

Correspondence Address: COGNIS CORPORATION, PATENT DEPARTMENT, 300 BROOKSIDE AVENUE, AMBLER, PA, 19002, US

(21) Appl. No.: 10/399,417

(22) PCT Filed: Oct. 6, 2001
(86) PCT No.: PCT/EP01/11546

(51) Int. Cl. C08K 5/10

(52) U.S. Cl. 524/315

(57) ABSTRACT

A dust-free stabilizer additive for use in plastics, the additive comprising agglomerates containing: (a) a plurality of stabilizer composition particles; and (b) a binder composition encapsulating the stabilizer composition, the binder composition containing at least one binder component having a melting point lower than a melting point of the stabilizer composition particles.

### FIELD OF THE INVENTION

This invention relates to dust-free stabilizer compositions for plastics, more especially polyvinyl chloride (PVC), in granular form, the composition being substantially free from the plastics for which it is intended.

### PRIOR ART

Stabilizers are added to thermoplastics during processing in order to increase their stability. These stabilizers may be lead, cadmium, barium, calcium, tin and zinc compounds, more especially salts and metal soaps, and others. Apart from the stabilizers themselves, the stabilizer compositions also consist of lubricants, such as fatty acid esters, waxes, paraffins, etc., and fillers, such as chalk, kaolin, titanium dioxide, etc. Other auxiliaries, such as flow modifiers, may also be present in the stabilizer compositions.

The stabilizer compositions are incorporated in the plastics in powder form by the processor, the plastics also being present in powder form or in the form of very fine granules. The powder form of both components to be incorporated, i.e. the plastic and the stabilizer compositions, is favorable for obtaining a uniform and homogeneous mixture.

However, if the stabilizer compositions are present as powders for incorporation in the plastics, serious disadvantages arise. Since, as can be seen from the examples mentioned above, the stabilizer compositions often contain physiologically harmful constituents which should not be inhaled, special safety measures have to be taken during the processing of powder-form stabilizer compositions. Accordingly, totally encapsulated installations have been developed for the completely dust-free processing of the powder-form stabilizer composition from delivery to the final mixture of plastic and stabilizer composition and beyond. However, such installations are very expensive both in regard to initial cost and in regard to ongoing maintenance.

Another disadvantage of powder-form stabilizer compositions lies in the risk of explosion because they contain a significant percentage of organic compounds. Accordingly, special measures have to taken to avoid dust explosions.

For these reasons, it is known that stabilizer compositions can be made up in such a way that the advantages of the powder form are retained without having to accept any of their disadvantages.

To this end, the stabilizer compositions are converted into granules which the user processes in a special apparatus. The granules are introduced together with the plastic powder into a heating/cooling powder mixer with a vertical axis of rotation in which stirrer blades rotate at high speeds, typically 2,000 r.p.m. The stirrer reduces the stabilizer granules into a fine powder and, at the same time, mixes this powder with the plastic powder. About 2 to 8 parts by weight of the stabilizer compositions are mixed with 100 parts by weight of plastic powder in this way. Under the effect of mechanical shearing and the resulting friction, the temperature in the mixer rises very quickly so that it is important not to exceed a certain mixing time because other the plastic plasticizes and a partially plasticized block is obtained instead of the required powder mixture.

The mixture drops from the powder mixer into a tubular, horizontally arranged cooler with a longitudinal, i.e. likewise horizontally arranged, stirrer shaft on which stirrer blades are provided. In the cooler, the powder mixture is cooled to around 30 to 40° C. and is then directly further processed or transported to a storage silo.

The temperatures mentioned relate to the most common application in which PVC powder is mixed with a stabilizer composition. Temperatures of 145 to 210° C. are applied during processing, for example in an extruder or injection molding machine. By contrast, the typical plasticization temperature which must not be exceeded in the powder mixer is about 140° C.

Various supply forms which can be processed in the apparatus mentioned above are known. Thus, the stabilizer compositions can be cold-compacted by pressure to form granules. To obtain particularly dust-free compositions, correspondingly high pressures are of advantage. However, the high density achieved in this way leads to poor dispersibility of the granules in the plastic.

In addition, it is known that stabilizer compositions can be used in the form of flakes. To this end, the corresponding metal soaps are produced from the metal oxides and fatty acids in a melt reactor at temperatures of 130 to 150° C. These metal soaps often have an indefinable composition. After addition of fusible and infusible additives, a viscous melt with a temperature of 140° C. is obtained and is applied to a flake-forming roller to obtain flakes. The flakes are not uniform in shape and, in addition, are mechanically relatively unstable so that a product with a significant, unwelcome dust content is obtained.

Accordingly, it is more favorable to produce pellets rather than flakes from the melt. To this end, drops of the hot melt are applied by a punch to a cooling bed which may be formed by a cooled steel belt. Pellets have the advantage that they are almost completely dust-free and easier to disperse in the plastic powder because no mechanical pressure has been applied to produce the pellets. The pellets have a diameter of about 3 to 4 mm.

Although pellets have the advantage of being dust-free and easy to process, stabilizer compositions with high metal contents, especially lead salt contents, as necessary for cable plastics for example, cannot be produced in the form of pellets because stabilizer compositions such as these are difficult to melt. Plastics intended for the sheathing of electrical cables require stabilizer compositions containing 50 to 70% by weight or even up to 75% by weight of lead sulfate. Although fatty alcohols can be added, for example in quantities of 5 to 10% by weight, to the stabilizer compositions to reduce their viscosity, so that the composition can be pelleted, the presence of fatty alcohols is undesirable in cable compounds and even intolerable in the case of flexible PVC. The problems to do with the fusibility of the stabilizer composition do not arise with lead contents of less than 50% by weight so that fatty alcohols do not have to be added.

In addition, DE-A-34 29 766 describes a granular stabilizer for PVC and a process for its production. The process starts out from a powder-form stabilizer mixture and a solid organic binder. The binder is used in a quantity of 2 to 15 parts by weight to 100 parts by weight of the powder-form stabilizer composition. The binder may also be a typical constituent of the stabilizer mixture, for example lead stearate, or even a low-melting wax. It is important that the binder is added in a quantity which is smaller than the “critical liquid absorption” of the powder-form stabilizer composition defined in the cited document.

In a first step, the powder-form stabilizer mixture is size-reduced to so-called “primary particles” of which the particle size is not discussed. However, it may be concluded from the size-reducing machines used, for example high-speed mills, that the particle sizes are in the nanometer range. During its size reduction, the powder-form stabilizer mixture is mixed with the binder mentioned either in the dry state or in the presence of solvents, so that the surface of the primary particles is covered by binder.

In a second step, the coated primary particles obtained are granulated to particle sizes of 0.1 to 2 mm by melting of the surface layer, i.e. at a higher temperature than the melting point of the binder, optionally after removal of the solvent. The end product consists of granules each made up of several primary particles which in turn are individually covered by the binder.

Although, as a result of the drastic size reduction of the stabilizer mixture into primary particles, favorable dispersion behavior in the plastic is obtained by virtue of the very small particle size, the considerable effort involved in the drastic size reduction is a disadvantage. If typical constituents of the stabilizer mixture, for example lead stearate, are used as the binder, as proposed in the cited document, the effort involved in avoiding explosions of the “high-dust” powder is a disadvantage. In view of their very large relative surface, the primary particles also have a tendency towards dust explosions against which suitable measures have to be taken. For example, the size reduction of the starting materials to primary particles could be undertaken in the presence of a solvent although this does have the disadvantage that, after this process step, the solvent has to be removed by distillation in another step before the primary particles are granulated.

A process for the production of additives for plastics and the corresponding additives in granular form are known from WO-A-87 00543. Here, the binder—which is referred to in this document as “wax”—is added to the other constituents in molten form in several fractions, i.e. gradually, in a high-speed mixer. When the first fraction of the binder is added, the individual powder particles take on a thin coating of the binder. When the other fractions of the binder are added, the “waxed” particles undergo aggregation so that the granules obtained consist entirely of the binder mentioned, for example glycerol monostearate, in which the other particles are embedded as in a matrix. Accordingly, in the production of these granules, the binder has to be added in the molten state, i.e. at a temperature above the melting temperature. In addition, during the incorporation of these additive granules in the plastic for which they are intended, the binder again has to be completely melted to ensure uniform dispersion in the plastic.

In addition, DE-A-2 031 445 describes a process for the granulation of auxiliaries for stabilizing halogen-containing vinyl polymers. To produce the granules, molten binder is again added to the other components.

### DESCRIPTION OF THE INVENTION

The problem addressed by the present invention was to provide a stabilizer composition for plastics, more particularly PVC, which would be dust-free during transportation and on delivery, would be as readily dispersible in the plastic as powder-form compositions and would allow high inorganic lead salt contents without the addition of fatty alcohols. The composition would readily disintegrate into powder in the mixer so that it could be incorporated in the plastic without any dispersion problems.

This problem has been solved by the stabilizer composition mentioned at the beginning which is characterized in that each agglomerate grain consists of several particles of the stabilizer composition and is completely surrounded by a layer of a binder which contains the lowest-melting component of the stabilizer composition, the interior of the agglomerate grain being poor in this binder and containing the above-mentioned particles of the stabilizer composition in a flowable state. In the context of the invention, the term “agglomerate” is used synonymously with the term “granules”. Accordingly, the terms “agglomeration” and “granulation” are synonyms, as are the terms “agglomerator” and “granulator”.

Accordingly, the present invention relates to dust-free stabilizer compositions for plastics in agglomerate form, the composition being substantially free from the plastics for which it is intended, each agglomerate grain consisting of several particles of the stabilizer composition and being completely surrounded by a layer of a binder which contains the lowest-melting component of the stabilizer composition, the interior of the agglomerate grain being poor in this binder and containing the above-mentioned particles of the stabilizer composition in a flowable state.

In a preferred embodiment, polyvinyl chloride is used as the plastic.

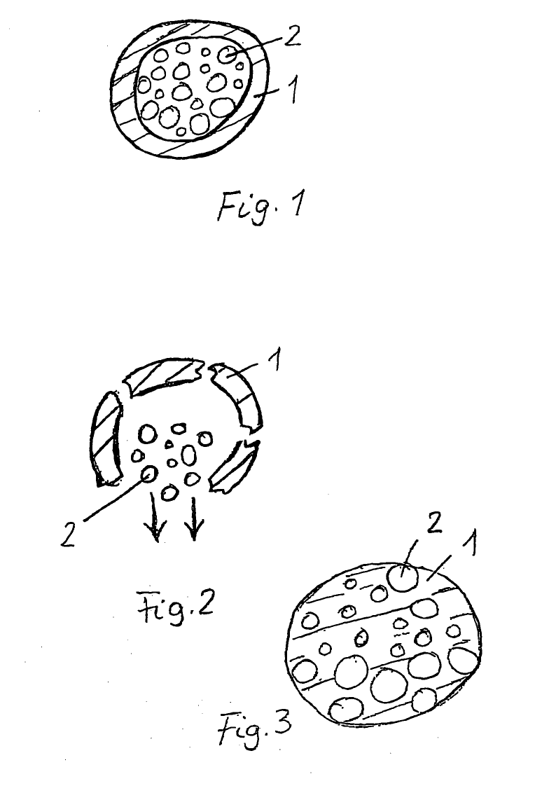

The granules (agglomerates) according to the invention are substantially spherical in shape with a compact outer solid layer consisting of the binder mentioned. FIG. 1 is a schematic section through one such agglomerate grain. The powder-form stabilizer composition is located within the outer layer 1 in a non-caked, i.e. loose and flowable, form. Accordingly, the outer shell corresponds to a pack for the powder-form product. Each agglomerate grain contains virtually the entire formulation of the stabilizer composition so that troublesome separation cannot occur. In the prior art, such separation occurs relatively quickly in powder-form stabilizer compositions, for example simply through the transportation of the compositions, because the densities of the individual powder particles are very different. It should be remembered that both lead compounds and purely organic compounds, such as waxes and fatty acid derivatives, are or may be present in compositions of the type in question.

When the agglomerate grains according to the invention are incorporated by mixing in the plastic powder at normal temperatures, i.e. not at elevated temperature, the outer layer 1 breaks apart and the powder particles 2 flow out of the outer layer 1 and are dispersed in the plastic powder (FIG. 2). Accordingly, despite the total absence of dust, the dispersion behavior of the powder particles in the plastic is equivalent to that of known powder-form stabilizer compositions. The agglomerate grains according to the invention have the further advantage that no heating is required for incorporation. It is sufficient to incorporate the agglomerate grains in the plastic powder by mixing at low temperature in a cold mixer. The outer solid layer of binder breaks apart solely under the effect of mechanical stress and releases the powder-form mixture. Basically, there is no need here for incorporation with a high-speed mixer at elevated temperatures, for example about 140° C., as is the case in the prior art. This high temperature required in the prior art is necessary for completely melting the binder so that the individual solid particles of the stabilizer composition can be dispersed. However, since—according to the invention—the particles are present in flowable form inside each agglomerate grain, the binder does not have to melt, and certainly not completely, during incorporation of the agglomerate grains according to the invention. It is sufficient for the outer layer to break up so that the powder flows out.

In addition, there is no need in accordance with the invention for the starting materials for the stabilizer composition to be size-reduced to primary particles in a first step. The particle size in which the components of the stabilizer compositions are normally supplied guarantees good dispersibility in the plastic. Since there is no need to melt the stabilizer compositions, as there is in the known process for producing pellets, high lead salt contents can also be accommodated in the composition. The absence of dust is achieved by the coating of the agglomerates with the lowest-melting component of the stabilizer composition.

Another advantage of the stabilizer composition according to the invention is that no additional binder is used for agglomeration because the percentages by weight of the components in the stabilizer composition are not altered by the agglomeration process.

In a preferred embodiment, the lowest-melting component makes up from 1 to 20% by weight and more particularly from 5 to 10% by weight of the stabilizer composition. The optimal value in each individual case depends upon the percentages of the other constituents of the stabilizer composition. In another embodiment, the lowest-melting component has a melting point below 100° C. Accordingly, low temperatures are sufficient for the agglomeration process.

In another embodiment of the invention, the binder contains a lubricant for the processing of plastics. However, other low-melting components of the stabilizer composition may also be used as binder for the agglomerate according to the invention.

Another embodiment of the invention is characterized in that the binder contains a lubricant from the group consisting of C₈₋₂₄ fatty acids, C₁₂₋₂₄ fatty alcohols, esters of C₈₋₂₄ fatty acids and C₆₋₂₄ fatty alcohols, esters of C₈₋₂₄ fatty acids and polyhydric alcohols containing 4 to 6 hydroxyl groups and hydroxystearic acid esters. The compounds mentioned may be used both individually and in the form of mixtures with one another.

Suitable C₈₋₂₄ fatty acids are both native and synthetic, linear saturated compounds of this class. If fatty acid mixtures are used, they may contain small quantities of unsaturated fatty acids, with the proviso that the melting point of such mixtures is always above 25° C. Examples of fatty acids which may be used as a solid fusible component are caprylic, capric, lauric, tridecanoic, myristic, pentadecanoic, palmitic, margaric, stearic, behenic and lignoceric acid. Fatty acids containing hydroxyl groups, such as 12-hydroxystearic acid, are also suitable. Fatty acids such as these can be obtained from naturally occurring fats and oils, for example through lipolysis at elevated temperature and pressure and subsequent separation of the fatty acid mixtures obtained, optionally followed by hydrogenation of the double bonds present. Technical fatty acids are preferably used here. They are generally mixtures of different fatty acids of a certain chain length range with one fatty acid as the main constituent. C₁₂₋₁₈ fatty acids are preferably used.

The C₁₂₋₂₄ fatty alcohols suitable as the fusible component are linear saturated representatives of this class of substances which all have a melting point above 25° C. Corresponding fatty alcohols may be obtained inter alia from naturally occurring fats and oils by transesterification with methanol, subsequent catalytic hydrogenation of the methyl esters obtained and fractional distillation. Synthetic fatty alcohols obtained, for example, by oxo and Ziegler synthesis may also be used. Examples of such fatty alcohols are lauryl, myristyl, cetyl, stearyl and behenyl alcohol. These compounds may be used individually and in admixture with one another. Technical fatty alcohols are preferably used. They are normally mixtures of different fatty alcohols of a limited chain length range in which one particular fatty alcohol is present as the main constituent.

The above-mentioned esters of C₈₋₂₄ fatty acids and C₆₋₂₄ fatty alcohols should meet the requirement that their melting point is above 25° C. Suitable starting materials for the production of these fatty alcohol/fatty acid esters are the fatty acids and fatty alcohols already described in detail in the foregoing. The esters may additionally contain C₆₋₁₁ fatty alcohols, i.e. for example n-hexanol, n-octanol and n-decanol, as alcohol component. The esters mentioned may be obtained by known methods of organic synthesis, for example by heating stoichiometric quantities of fatty acid and fatty alcohol to 180-250° C., optionally in the presence of a suitable esterification catalyst, such as tin grindings, and in an inert gas atmosphere, and distilling off the water of reaction. Examples of esters suitable for use in accordance with the invention are stearyl caprylate, stearyl caprate, cetyl laurate, cetyl myristate, cetyl palmitate, n-hexanol stearate, n-octyl stearate, lauryl stearate, stearyl stearate, stearyl behenate, behenyl laurate and behenyl behenate. It is important in this connection to bear in mind that these esters are normally produced from technical starting materials which, in turn, are mixtures so that the corresponding esters are also mixtures.

Suitable starting materials for the production of the above-mentioned esters of C₈₋₂₄ fatty acids and alcohols containing 4 to 6 hydroxyl groups are, again, the fatty acids already described in the foregoing. The alcohol component may be selected, above all, from aliphatic polyols containing 4 to 12 carbon atoms, for example erythritol, pentaerythritol, dipentaerythritol, ditrimethylol propane, diglycerol, triglycerol, tetraglycerol, mannitol and sorbitol. These polyesters may be full esters in which all the hydroxyl groups of the polyol are esterified with fatty acid. However, polyol partial esters containing one or more free hydroxyl groups in the molecule are also suitable. These fatty acid polyol esters may also be obtained by known methods of organic synthesis by esterification of the polyols with stoichiometric or sub-stoichiometric quantities of free fatty acids. Examples of such polyol fatty acid esters are the stearic acid and stearic acid/palmitic acid full esters of erythritol, pentaerythritol and diglycerol, the dilaurates of dipentaerythritol, ditrimethylolpropane, triglycerol, mannitol and sorbitol, the distearates of erythritol, pentaerythritol, dipentaerythritol and tetraglycerol and the so-called sesquiesters of pentaerythritol, dipentaerythritol, mannitol and sorbitol in whose production 1.5 mol fatty acid, more particularly palmitic and/or stearic acid, is used to 1 mol polyol. The polyol fatty acid esters mentioned are generally mixtures simply because of the particular starting materials used. In this case, too, only products with a melting point above 25° C. may of course be considered.

One particular group of possible low-melting components in the context of the present invention are the esters of hydroxystearic acid. This is because both compounds in which the hydroxystearic acids are esterified through their carboxyl group with a mono- or polyhydric alcohol and compounds in which they are esterified with fatty acids through their hydroxyl group are suitable for use. Derivatives of 12-hydroxystearic acid which may be obtained, for example, from the fatty acid component of hydrogenated castor oil are preferred. Derivatives of the first-mentioned type include 12-hydroxysteric acid esters of the fatty alcohols described in detail in the foregoing and 12-hydroxystearic acid full and partial esters with polyols containing 2 to 6 hydroxyl groups and 2 to 12 carbon atoms, more particularly those derived from ethylene glycol, 1,2- and 1,3-propylene glycol, the isomeric butylene glycols, 1,12-dodecanediol, glycerol, trimethylolpropane, erythritol, pentaerythritol, ditrimethylolpropane, dipentaerythritol, diglycerol, triglycerol, tetraglycerol, mannitol and sorbitol. Examples of such esters are the 12-hydroxystearic acid full esters of ethylene glycol, 1,3-propylene glycol, erythritol and pentaerythritol, the di-12-hydroxystearates of pentaerythritol, dipentaerythritol, diglycerol, tetraglycerol and sorbitol and the 12-hydroxystearic acid sesquiesters of pentaerythritol, dipentaerythritol and mannitol. Another member of this group is hydrogenated castor oil which is known to be a triglyceride mixture with a fatty acid component mainly consisting of 12-hydroxystearic acid. 12-Hydroxystearic acids of the second type are esterification products of 12-hydroxystearic acid and the C₈₋₂₄ fatty acids already described in detail in the foregoing. Within this group of 12-hydroxystearic acid derivatives, particular significance attaches to the esterification product of 12-hydroxystearic acid and behenic acid because it has the characteristic property of dispersing the stabilizer composition so thoroughly in plastic melts that its use enables the quantities in which the other components of the stabilizer composition are normally used to be considerably reduced. In addition, this esterification product has such a favorable melting point of 60° C. that the agglomerates according to the invention can be produced at correspondingly low temperatures. On the other hand, the melting point is high enough to allow the agglomerates to be stored without caking together or showing signs of exudation, even at summer temperatures.

In another embodiment of the present invention, the binder contains glycerol monostearate. A stabilizer composition of this type enables the other components to be coated with the inexpensive glycerol monostearate at relatively low temperatures. In addition, glycerol monostearate is a very good lubricant in polyvinyl chloride. Finally, glycerol monostearate is highly compatible with other additives incorporated in polyvinyl chloride.

It is pointed out that the term “glycerol monostearate” encompasses both pure glycerol monostearate and mixtures containing various quantities of glycerol di- and tristearate, depending on the purity of the glycerol monostearate. Typical values are 40-50% monostearate, 30-43% distearate and 8-10% tristearate.

For the purposes of the disclosure, reference is expressly made to the “stabilizers”, “stabilizing aids”, “lubricating stabilizers”, “lubricants” and “resin modifiers” mentioned in DE-A-34 29 766 which may be present in the agglomerate according to the invention. The lowest-melting component forms the binder for coating the other components of the stabilizer composition.

In a preferred embodiment, 95% of the particle size of the agglomerates according to the invention is at most 4 mm and more particularly from 0.5 to 2 mm.

The present invention also relates to a process for the production of a dust-free stabilizer composition for plastics, more particularly for PVC, the composition being substantially free from the plastics for which it is intended and the dust-free stabilizer composition being produced by agglomeration of a mixture of the powder-form composition in an agglomerator/mixer at a temperature substantially equal to the melting point of the lowest-melting component.

A process such as this is already known from the above-cited DE-A34 29 766.

Here, the above-stated problem addressed by the invention is solved by agglomeration of a mixture in which each particle consists of only one material and by introduction of all the components of the mixture to be agglomerated into the agglomerator/mixer in solid form.

In contrast to the prior art where the binder is often added to the other components in molten form for agglomeration, it is important in the process according to the invention that all the components, i.e. the binder included, are introduced into the agglomerator in solid rather than molten form. The agglomerates obtained in this way are not agglomerates in which the solid particles are embedded in a solid matrix consisting of the binder. Instead, the agglomerate grains according to the invention which contain only an outer layer of the binder are obtained, the interior of each agglomerate grain being poor in the binder and containing the solid other components of the stabilizer composition in powder, flowable and uncaked form.

The agglomeration process itself is accompanied by relatively slow stirring so that no significant increase in temperature is caused by the stirring. The agglomeration process takes place at about the melting point of the binder, i.e. the lowest-melting component. Since the slow stirring precludes any increase in temperature through friction, it is recommended to use a heated mixer which has the advantage that the required temperature can be adjusted relatively exactly. In addition, it is favorable to heat the mixer slowly. This promotes the formation of the agglomerate grains according to the invention. Accordingly, the mixer used is not the dry-blend friction mixer otherwise used in the prior art which rotates relatively quickly and heats the mixture to be agglomerated through friction.

In one advantageous embodiment, the entire mixture to be agglomerated is introduced into the agglomerator/mixer in only one step in contrast to the prior art.

For illustration purposes, a typical agglomerate grain according to the prior art is schematized in section in FIG. 3. It can clearly be seen that the individual solid particles 2 of the stabilizer composition are embedded in a solid sphere of the binder 1 as in a matrix. This agglomerate grain cannot be dispersed by mechanical action alone as the agglomerate grains according to the invention can. Instead, the binder 1 has to be fully melted to enable the powder particles to be dispersed in the plastic.

Accordingly, the process according to the invention corresponds less to granulation by the processes known from the prior art and more to a pill coating process as used in the pharmaceutical industry for completely enveloping solid particles, i.e. for coating. In contrast to the pill coating process, several small powder particles rather than a single large particle are encapsulated in a skin consisting of the binder.

In addition, in the process according to the invention, in contrast to the process according to DE-A-34 29 766, the stabilizer composition is granulated without any pretreatment with the binder present in the composition.

At least one of the components of the stabilizer composition preferably has a melting point below 100° C. This component serves as binder for completely enveloping the other components during the agglomeration process.

In another embodiment of the process according to the invention, the agglomeration process is carried out in a mixer, more particularly a heating/cooling mixer, at temperatures of up to 100° C. and more particularly at temperatures of 60 to 80° C. In addition, in the practical application of the process, it is of advantage to carry out agglomeration for only a short time because otherwise the mixture becomes too viscous so that the necessary motor power increases too greatly. The optimal time—which is also dependent upon the agglomeration temperature adjusted—can easily be determined by practical tests. A “heating/cooling mixer” in the context of the invention is understood to be a mixer or agglomerator in which one section can be heated and the other section cooled. The process is initially carried out in the heated mixer, the product obtained there being cooled down to the required temperature in the cooling section.

In another advantageous embodiment, the agglomeration process is carried out in a mixer with wall-sweeping strippers. Caking of the agglomerates on the walls is easily avoided in this way. For the same reason, the agglomeration process is carried out in a mixer with bottom scrapers.

It has also proved to be of advantage to use mixers with a certain height-to-diameter ratio. A height-to-diameter ratio of 0.1 to 0.5 is advantageous.

The invention is illustrated by the following Examples and Comparison Example.

1. Dust-free stabilizer compositions for plastics in agglomerate form, the composition being substantially free from the plastics for which it is intended, each agglomerate grain consisting of several particles of the stabilizer composition and being completely surrounded by a layer of a binder which contains the lowest-melting component of the stabilizer composition, the interior of the agglomerate grain being free from this binder and containing the above-mentioned particles of the stabilizer composition in a flowable state.

2. A stabilizer composition as claimed in claim 1, characterized in that the lowest-melting component makes up from 1 to 20% by weight and more particularly from 5 to 10% by weight of the stabilizer composition.

3. A stabilizer composition as claimed in any of the preceding claims, characterized in that the lowest-melting component has a melting point below 100° C.

4. A stabilizer composition as claimed in any of the preceding claims, characterized in that the binder contains a lubricant for the processing of plastics.

5. A stabilizer composition as claimed in the preceding claims, characterized in that the binder contains a lubricant from the group consisting of C₈₋₂₄ fatty acids, C₁₂₋₂₄ fatty alcohols, esters of C₈₋₂₄ fatty acids and C₆₋₂₄ fatty alcohols, esters of C₈₋₂₄ fatty acids and polyhydric alcohols containing 4 to 6 hydroxyl groups and hydroxystearic acid esters.

6. A stabilizer composition as claimed in the preceding claim, characterized in that the binder contains an esterification product of hydroxystearic acid and behenic acid.

7. A stabilizer composition as claimed in claim 5, characterized in that the binder contains glycerol monostearate.

8. A stabilizer composition as claimed in any of the preceding claims, characterized in that 95% of the particle size of the agglomerates is at most 4 mm and more particularly from 0.5 to 2 mm.

9. A process for the production of a dust-free stabilizer composition for plastics, the composition being substantially free from the plastics for which it is intended and the dust-free stabilizer composition being produced by agglomeration of a mixture of the powder-form composition in an agglomerator/mixer at a temperature substantially equal to the melting point of the lowest-melting component, characterized in that a mixture in which each powder particle consists of only one material is granulated and in that all the components of the mixture to be agglomerated are introduced into the agglomerator/mixer in solid form.

10. A process as claimed in claim 9, characterized in that the entire mixture to be agglomerated is introduced into the agglomerator/mixer in only one step.

11. A process as claimed in claim 9 or 10, characterized in that at least one of the components of the stabilizer composition has a melting point below 100° C.

12. A process as claimed in claim 11, characterized in that the agglomeration process is carried out in a mixer, more particularly a heating/cooling mixer, at temperatures of up to 100° C. and more particularly at temperatures of 60 to 80° C.

13. A process as claimed in any of claims 9 to 12, characterized in that the agglomeration process is carried out in a mixer with wall-sweeping strippers.

14. A process as claimed in any of claims 9 to 13, characterized in that the agglomeration process is carried out in a mixer with bottom scrapers.

15. A process as claimed in any of claims 9 to 14, characterized in that the agglomeration process is carried out in a mixer with a height-to-diameter ratio of 0.1 to 0.5.
